(19) United States
(12) Patent Application Publication
(10) Pub. No.: US 2021/0156060 A1
(43) Pub. Date: May 27, 2021

(54) LOW BASIS WEIGHT FLAME RETARDANT SCRIM, ARTICLES, AND METHODS

(71) Applicant: 3M INNOVATIVE PROPERTIES COMPANY, St. Paul, MN (US)

(72) Inventors: Eumi Pyun, St. Paul, MN (US); Liyun Ren, Woodbury, MN (US); Pingfan Wu, Woodbury, MN (US)

(21) Appl. No.: 17/258,484

(22) PCT Filed: Jul. 27, 2019
(86) PCT No.: PCT/US2019/042814

§ 371 Date: Jan. 7, 2021

Related U.S. Application Data
(63) Continuation-in-part of application No. PCT/CN2018/096648, filed on Jul. 28, 2018.
(60) Provisional application No. 62/824,510, filed on Mar. 27, 2019.

(51) Int. Cl. D04H 1/4291; D06M 15/263; D06M 11/71; H01M 10/658; D04H 1/593; D04H 1/587

(52) U.S. Cl. CPC D04H 1/4291; D06M 15/263; D06M 11/71; D06M 2101/30; D04H 1/593; D04H 1/587; D06M 2200/30; H01M 10/658

(57) ABSTRACT

A scrim is described comprising a plurality of fibers and a coating disposed on the scrim wherein the coating comprises a binder and a flame retardant additive. The scrim has a basis weight less than or equal to 200 grams/m² and passes the UL94-V0 flammability standard. The scrim may be incorporated into other articles and methods. Also described is a flame retardant coating composition.

### FIELD OF THE INVENTION

Provided are low basis weight flame retardant scrims and articles suitable for use in thermal insulation. In one embodiment, the flame retardant scrims may be used as scrims of multilayer thermal insulators in automotive and aerospace applications, such as battery compartments for electric vehicles.

### BACKGROUND

The importance of thermal management in electric vehicles cannot be overstated. Temperature has a profound effect on the performance and serviceable lifetime of lithium ion batteries. Freezing temperatures decrease vehicle acceleration and impact driving range. On the other extreme, high temperatures are also detrimental because such temperatures can result in power fade and degrade battery life. Consumers have come to expect that such batteries will perform nominally for many years when used in a wide range of geographies and climates.

A passive thermal insulator can substantially boost the efficiency of a lithium ion battery. Lithium ion batteries are known for having high power densities, but are limited by their narrow working temperature range. For example, working temperatures can be managed by a chiller that activates when battery temperature exceeds a certain temperature (e.g., 45° C.) and an electrical heater that activates when the temperature falls below a certain temperature (e.g., 15° C.). Heating and cooling devices can be powered by a lead-acid battery or other conventional batter to maintain the lithium battery pack within optimal temperatures. A great deal of energy can be required to warm up, or cool, the battery pack. A passive thermal insulator can greatly reduce this energy expenditure.

Engineering thermal management solutions can be complicated by safety implications. In some countries, regulations require that an electric vehicle needs to reach certain mileage milestones for a single charge and battery power density to qualify for government incentives. Yet, high power densities can increase the risk of a battery component catching fire. As a result, components of the battery and the compartment around the battery are required to be flame resistant. For passive thermal insulation materials, for example, and other uses manufacturers require that these materials pass the UL94-V0 flammability test.

### SUMMARY

Presently described is a scrim comprising a plurality of thermoplastic fibers having a melt point less than 350° C. and a coating disposed on the scrim. The coating comprises a non-halogenated binder and a flame retardant additive. The scrim has a basis weight less than or equal to 150 grams/m² and passes the UL94-V0 flammability standard. In some embodiments, the plurality of fibers comprise at least one thermoplastic polymer selected from polyester, polyolefin, polyphenylene sulfide, and polylactic acid polymer. The plurality of fibers typically have a basis weight ranging from 5 to 100 grams/m². The binder comprising the flame retardant additive typically has a basis weight of at least 50 grams/m². The basis weight of the plurality of fibers is typically less than the basis weight of the binder comprising the flame retardant additive. In some embodiments, the flame retardant additive comprises ammonium polyphosphate. In some embodiments, the binder further comprises a char forming material comprising —CH₂OH groups, such as lignin and sucrose.

In another aspect, an article is described comprising the flame retardant scrim described herein disposed on a release liner.

Oxidized polyacrylonitrile (“OPAN”) has various physical properties that make it suitable for passive insulation applications, since it can be formed into lofty fibrous structures and is non-flammable. One technical issue related to OPAN relates to its tendency to “shed” fibers. Fiber shedding is not only a contamination concern but also aesthetically problematic because OPAN fibers are black in color making them very visually prominent even in tiny quantifies. This is a problem for not only OPAN fibers but also other fibers that are non-meltable, because such fibers do not naturally weld or bond to each other when formed into a web, and thus easily become airborne.

One way to solve the problem of fiber shedding is to seal the OPAN fibers between an outer lining that traps the fibers and prevents them from becoming airborne. In a manufacturing process, this could be accomplished by edge sealing—for example, using a hot press to melt the edge and solidify the web in the thickness direction. This is not possible with OPAN fibers, which do not melt, but can be achieved using a material that is both heat-sealable and flame resistant.

Also provided herein are nonwoven articles with an OPAN core layer confined between a pair of flame-resistant scrims that enable the insulator to be heat sealed along its edge. Advantageously, the encapsulated article can be made to be substantially dust free, or have substantially no fiber shedding. Further, the encapsulated article can pass the UL-94 V0 flammability standard, and is technically suitable for use in electric vehicle applications.

Thus, in another aspect, a multilayer thermal insulator is provided. The multilayer thermal insulator comprises: a non-woven core layer comprising non-meltable, flame-resistant polymeric fibers; and one or more scrims disposed on opposing major surfaces of the non-woven core layer, wherein a peripheral edge of the one or more scrims is either edge sealed or capable of being edge sealed to substantially encapsulate the non-woven core layer within the one or more scrims.

In another aspect, a battery assembly for an electric vehicle is provided comprising the multilayer thermal insulator.

In another aspect, a method of making a multilayer thermal insulator containing a non-woven core layer comprising non-meltable, polymeric fibers is provided, the method comprising: disposing a scrim along each major surface of the non-woven core layer; and edge sealing a peripheral edge of the scrim(s) to substantially encapsulate the non-woven core layer within the scrim(s).

In another aspect, a preferred (e.g. aqueous) flame retardant composition is described comprising: water, a latex binder comprising an acrylic polymer having a glass transition temperature (Tg) ranging from −20° C. to 20° C.; flame retardant particles comprising ammonium polyphosphate; and a char forming material selected from lignin, sucrose, or a combination thereof.

### BRIEF DESCRIPTION OF THE DRAWINGS

FIG. 1 is a side cross-sectional views of a multilayer thermal insulator prior to being heat sealed including scrims as described herein;

FIGS. 2-3 are side cross-sectional views of respective multilayer thermal insulators after being heat sealed; and

FIG. 4 is a schematic diagram of an exemplary method of making the multilayer thermal insulator.

Repeated use of reference characters in the specification and drawings is intended to represent the same or analogous features or elements of the disclosure. It is understood that numerous other modifications and embodiments can be devised by those skilled in the art, which fall within the scope and spirit of the principles of the disclosure. The figures are not drawn to scale.

### Definitions

As used herein:

“ambient conditions” means at 25° C. and 101.3 kPa pressure;

“average” means number average, unless otherwise specified;

“copolymer” refers to polymers made from repeat units of two or more different polymers and includes random, block and star (e.g. dendritic) copolymers;

“average fiber diameter” of fibers in a non-woven core layer is determined by producing one or more images of the fiber structure, such as by using a scanning electron microscope; measuring the transverse dimension of clearly visible fibers in the one or more images resulting in a total number of fiber diameters; and calculating the average fiber diameter based on that total number of fiber diameters;

“non-woven core layer” means a plurality of fibers characterized by entanglement or point bonding of the fibers to form a sheet or mat exhibiting a structure of individual fibers or filaments which are interlaid, but not in an identifiable manner as in a knitted fabric;

“polymer” means a relatively high molecular weight material having a molecular weight of at least 10,000 g/mol;

“size” refers to the longest dimension of a given object or surface;

“substantially” means to a significant degree, as in an amount of at least 30%, 40, 50, 60, 70, 80, 90, 95, 96, 97, 98, 99, 99.5, 99.9, 99.99, or 99.999%, or 100%; and

“thickness” means the distance between opposing sides of a layer or multilayer article.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

### Multilayer Constructions

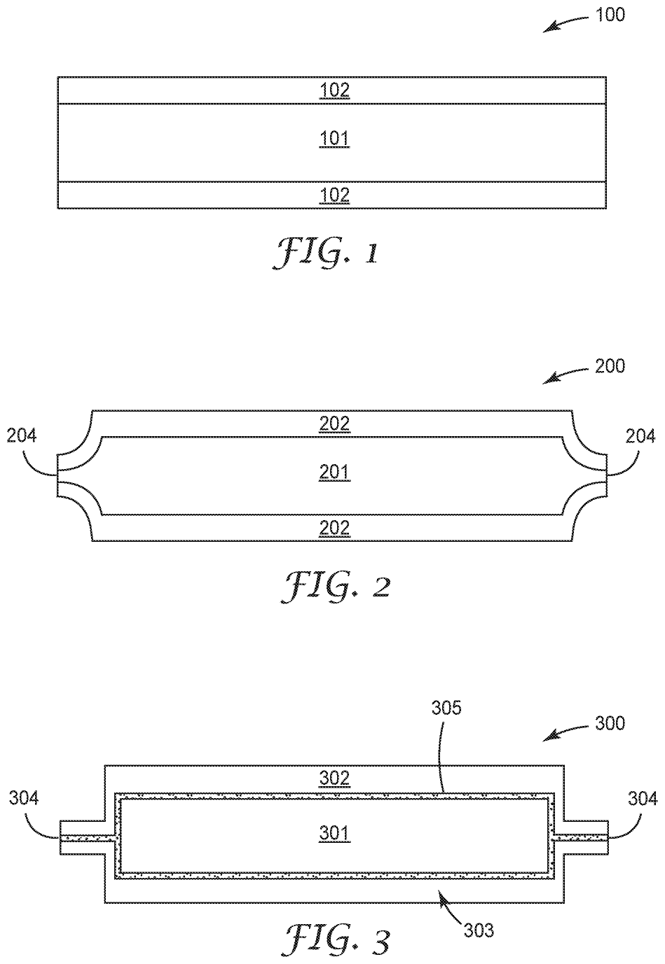

An unsealed thermal insulator according to one embodiment is shown in FIG. 1 and hereinafter referred to by the numeral 100. The unsealed thermal insulator 100 includes a non-woven core layer 101 disposed between a pair of scrims 102, 102. As shown, the scrims 102, 102 are diametrically opposed, with each scrim 102 extending across and directly contacting the non-woven core layer 101.

In this case, the two scrims 102, 102 do not contact each other at any point. In some embodiments, the scrims 102, 102 could be joined to each other along one or more peripheral edges of the unsealed thermal insulator 100 to form an envelope, or pouch, within which the non-woven core layer 101 resides.

As a further possibility not shown in FIG. 1, the scrims 102, 102 themselves could represent two halves of a single scrim that is folded over along one peripheral edge of the unsealed thermal insulator 100, with the non-woven core layer 101 disposed between the two halves.

FIG. 2 shows a thermal insulator 200 obtained by edge sealing the unsealed thermal insulator 100 of FIG. 1. Like the thermal insulator 100, the thermal insulator 200 is comprised of a non-woven core layer 201 of non-meltable fibers, where the non-woven core layer 201 is sandwiched between a pair of scrim layers 202. As shown in this figure, the peripheral edges 204, 204 of the thermal insulator 200 are permanently compressed, or edge sealed. Edge sealing substantially encapsulates the non-woven core layer 201, along with any loose fibers therein, between the pair of scrim layers 202. Advantageously, only the edges can be sealed, thus avoiding the degradation in insulation performance that might be caused by compressing large areas of the thermal insulator 200.

The peripheral edges of the scrims 202, 202 can be joined using any known method. One method is heat sealing, where heat and pressure is applied to outer-facing surfaces of the scrims 202, 202 to compress and force out voids in both the scrims 202, 202, and the non-woven core layer 201 to form a seal. Alternatively, edge sealing can be achieved by cold welding, a process in which two surfaces join without any liquid or molten phase being present at the joint. As yet another alternative, edge sealing can take place adhesively, where a liquid adhesive fills the interstices within the scrims 202, 202 and the non-woven core layer 201 along the edge seal. Each method can effectively prevent escape of loose fibers.

The non-woven core layer and scrims need not be mutually coextensive. For example, the scrims 102, 102 can be made larger in area than the non-woven core layer 101 such that the peripheral edges of the scrims 102, 102 do not overlap with the peripheral edge of the non-woven core layer 101. The peripheral edge may extend along the entire perimeter of the thermal insulator 100 and include the scrims 102, 102 but exclude the non-woven core layer 101. Advantageously, this allows the peripheral edges of the scrims 102, 102 to be edge sealed in a way that prevents fibers from the non-woven core layer 101 from being exposed on the outer surface of the finished product.

FIG. 3 shows a sealed thermal insulator 300 with an added feature to prevent shifting or sliding of the layers of the thermal insulator relative to each other. Here, the thermal insulator 300 has a non-woven core layer 301 sandwiched between a pair of scrims 302, 302 as shown in the previous embodiment. The scrims 302, 302 have peripheral edges 304 that extend beyond those of the non-woven core layer 301, with the thermal insulator 300 edge sealed along these peripheral edges 304.

Unlike the previous embodiment, the thermal insulator 300 additionally includes an adhesive layer 305 that bonds the non-woven core layer 301 and scrims 302, 302 to each other, as shown. The adhesive layer 305 prevents sliding movement between the non-woven core layer 301 and scrims 302, 302. The adhesive layer 305 enables the thermal insulator 300 to be edge sealed using the adhesive layer 305 alone, without need for a separate binder.

The adhesive layer 305 can be comprised of any suitable adhesive. Suitable adhesives can include heat-activated adhesives containing polyurethanes or acrylates. In some embodiments, the adhesive is stimuli-responsive. For example, the adhesive layer 305 can be initially non-tacky, enabling it to be stored unprotected by a release liner, but become tacky upon activation by heat. Exemplary materials are described in Y. L. Dar, W. Yuan-Huffman, S. Shah, and A. Xiao, J. Adhesion Sci. Technol., 21, 1645 (2007). The adhesives can also blended with flame retardant agents such as bromine, phosphate, and iodine salts.

Various factors can influence the mechanical properties of the provided multilayer constructions, including fiber dimensions, the presence of any binding sites on the reinforcing fibers, fiber entanglements, and overall bulk density. Tensile strength and tensile modulus are metrics by which the properties of the non-woven core layer may be characterized.

The tensile modulus is generally indicative of the stiffness of the material and can be from 7 kPa to 1400 kPa, 70 kPa to 550 kPa, 140 kPa to 350 kPa, or in some embodiments, less than, equal to, or greater than 5 kPa, 7, 10, 15, 20, 25, 30, 40, 50, 60, 70, 80, 90, 100, 120, 140, 150, 200, 250, 300, 350, 400, 450, 500, 550, 600, 700, 800, 900, 1000, 1100, 1200, 1300, or 1400 kPa. Tensile strength represents the resistance of the non-woven core layer to tearing or permanently distorting and can be at least 28 kPa, at least 32 kPa, at least 35 kPa, or in some embodiments, less than, equal to, or greater than 28 kPa, 29, 30, 31, 32, 33, 34, 35, 36, 37, 38, 39, 40, 42, 44, 45, 47, or 50 kPa.

The provided thermal insulators may optionally include additional layers not shown in FIGS. 1-3. To assist in installation, for example, any of these exemplary thermal insulators may further include an outer adhesive layer, such as a pressure-sensitive adhesive layer or other attachment layer or fastening mechanism. Such a layer can extend across and contact one or both scrims, or any other outward-facing surface of the thermal insulator. As another possibility, any of these insulators may include a solid thermal barrier such as an aluminum sheet or foil layer adjacent to the non-woven core layer. For some applications, one or more acoustically insulating layers may also be coupled to the non-woven core layer.

Thermal insulation can be installed using any suitable method. The provided thermal insulators are not only conformable but are capable of being compressed and expanded to fill the cavities, or enclosures, in which they are housed. Enclosures used in electric vehicle applications may, in some instances, have thickness variations in the range of from 10% to 100% relative to the largest thickness dimension of the enclosure. The provided thermal insulators may, in an exemplary installation, be placed in compression within such an enclosure, and then allowed to expand and substantially fill the enclosure.

The resilience of these materials can be characterized based on their dimensional recovery shortly after being compressed. In preferred embodiments, for example, the thickness recovers to at least 70%, 72, 75, 77, 80, 82, 85, 87, 90, 92, or 95% of its original thickness 5 minutes after being compressed to 37% of its original thickness at ambient conditions.

Various components of the multilayered thermal insulators are described in more detail in the subsections that follow.

### Non-Woven Core Layer

The non-woven core layer is comprised of a plurality of non-meltable polymeric fibers. These are fibers made from a polymer that does not become a liquid at any temperature. In some cases, these polymers do not melt because they oxidize first when heated in the presence of air. The non-meltable polymeric fibers can include carbon fibers, carbon fiber precursors, or a combination thereof.

The non-meltable fibers are typically present in an amount from 30 wt-% to 100 wt-%, 50 wt % to 90 wt %, or 60 wt % to 80 wt-% based on the overall weight of the non-woven core layer.

Carbon fiber precursors include oxidized acrylic precursors, such as oxidized polyacrylonitrile. Polyacrylonitrile is a useful acrylic precursor that can be used widely to produce the carbon fibers. In some embodiments, the polyacrylonitrile contains more than 70 wt %, more than 75 wt %, more than 80 wt %, or more than 85 wt % of acrylonitrile repeat units.

Non-meltable polymeric fibers further include dehydrated cellulosic precursors such as rayon. Non-meltable polymeric fibers further include lignin fibers. Lignin is a complex polymer of aromatic alcohols known as monolignols, and is derived from plants. Monolignol monomers include p-coumaryl alcohol, coniferyl alcohol, and sinapyl alcohol, which are methoxylated to varying degrees relative to each other.

Non-meltable polymeric fibers also include certain thermoset materials, such as epoxy, polyimide, melamine, and silicone.

Natural fibers, such as cotton, linen, hemp, silk, and animal airs, burn before melting. Rayon is the artificial silk made from cellulose, which can have a chemical structure such as Structure I below. When cellulose burns, it produces carbon dioxide and water and also forms a char. Such a combustion reaction can be represented, for example, by the following reaction: C₆H₁₀O₅+6 O₂ ⇒6 CO₂+5 H₂O.

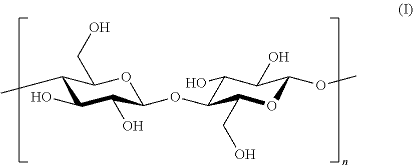

Carbon fiber precursors also include pitch-based precursors. Pitches are complex blends of polyaromatic molecules and heterocyclic compounds, which can be used as precursors of carbon fibers or carbon fillers in carbon composites. Vinylidene chloride and phenolic resins can, in some embodiments, also be precursors for manufacture of carbon fibers.

In an exemplary embodiment, the non-meltable fibers are comprised of oxidized polyacrylonitrile fibers. The oxidized polyacrylonitrile fibers can include, for example, those available under the trade designations PYRON (Zoltek Corporation, Bridgeton, Mo.) and PANOX (SGL Group, Meitingen, Germany).

The oxidized polyacrylonitrile fibers derive from precursor fibers containing a copolymer of acrylonitrile and one or more co-monomers. Useful co-monomers include, for example, methyl methacrylate, methyl acrylate, vinyl acetate, and vinyl chloride. The co-monomer(s) may be present in an amount of up to 15 wt %, 14 wt %, 13 wt %, 12 wt %, 11 wt %, 10 wt %, 9 wt %, or 8 wt %, relative to the overall weight of the monomer mixture prior to copolymerization.

Oxidation of the precursor fibers can be achieved by first stabilizing the precursor fibers at high temperatures to prevent melting or fusion of the fibers, carbonizing the stabilized fibers to eliminate the non-carbon elements and finally a graphitizing treatment at even higher temperatures to enhance the mechanical properties of the non-woven fibers. Oxidized polyacrylonitrile fibers, as referred to herein, include polyacrylonitrile fibers that are either partially or fully oxidized.

In some embodiments, the plurality of non-meltable polymeric fibers is stabilized. Stabilization can be carried out by controlled heating of the precursor fiber in air or some other oxidizing atmosphere. Oxidation typically takes place at temperatures in the range of from 180° C. to 300° C., with a heating rate of from 1-2° C. per minute.

If desired, the precursor fibers can undergo further processing to reduce shrinkage. Shrinkage of the precursor fibers can be reduced by stretching the fibers along their axis during the low-temperature stabilization treatment. Such stretching can produce oxidized polyacrylonitrile fibers with a high degree of preferred orientation along the fiber axis. The stabilization process produces changes in chemical structure of the acrylic precursor whereby the material becomes thermally stable to subsequent high temperature treatments. During this process, the fibers change in color to black. The black fibers are carbonized in an inert atmosphere at high temperatures, typically from 1000° C. to 1500° C., at a slow heating rate to avoid damage to the molecular order of the fiber. The fibers are given a graphitizing treatment at high temperatures for example, above 2000° C. to 3000° C. to improve the texture of the fiber and to enhance the tensile modulus of the non-woven core layer. If desired, the strength and the tensile modulus of the fibers can be further improved by stretching at elevated temperatures.

More generally, the non-meltable polymeric fibers used in the non-woven core layer can have a fiber diameter and length that enables the fibers to become entangled within the non-woven core layer. The fibers, however, are preferably not so thin that web strength is unduly compromised. The fibers can have an average fiber diameter of from 1 micrometers to 100 micrometers, from 2 micrometers to 50 micrometers, from 5 micrometers to 20 micrometers, from 10 micrometers to 30 micrometers or in some embodiments, less than, equal to, or greater than 1 micrometer, 2, 3, 5, 7, 10, 15, 20, 25, 30, 40, 50, 60, 70, 80, 90, or 100 micrometers.

Inclusion of long fibers can reduce fiber shedding and further enhance strength of the non-woven core layer along transverse directions. The non-meltable polymeric fibers can have a median fiber length of from 10 millimeters to 100 millimeters, from 15 millimeters to 100 millimeters, from 25 millimeters to 75 millimeters, or in some embodiments, less than, equal to, or greater than 10 millimeters, 12, 15, 17, 20, 25, 30, 35, 40, 45, 50, 55, 60, 65, 70, or 75 millimeters.

The non-meltable polymeric fibers used to form the non-woven core layer can be prepared from bulk fibers. The bulk fibers can be placed on the inlet conveyor belt of an opening/mixing machine in which they can be teased apart and mixed by rotating combs. The fibers are then blown into web-forming equipment where they are formed into a dry-laid non-woven core layer.

As an alternative, a SPIKE air-laying forming apparatus (commercially available from FormFiber NV, Denmark) can be used to prepare nonwoven fibrous webs containing these bulk fibers. Details of the SPIKE apparatus and methods of using the SPIKE apparatus in forming air-laid webs are described in U.S. Pat. Nos. 7,491,354 (Andersen) and 6,808,664 (Falk et al.).

Bulk fibers can be fed into a split pre-opening and blending chamber with two rotating spike rollers with a conveyor belt. Thereafter, the bulk fibers are fed into the top of the forming chamber with a blower. The fibrous materials can be opened and fluffed in the top of the chamber and then fell through the upper rows of spikes rollers to the bottom of the forming chamber passing thereby the lower rows of spike rollers. The materials can then be pulled down on a porous endless belt/wire by a combination of gravity and vacuum applied to the forming chamber from the lower end of the porous forming belt/wire.

Alternatively, the non-woven core layer can be formed in an air-laid machine. The web-forming equipment may, for example, be a RANDO-WEBBER device commercially-available from Rando Machine Co., Macedon, N.Y. Alternatively, the web-forming equipment could be one that produces a dry-laid web by carding and cross-lapping, rather than by air-laying. The cross-lapping can be horizontal (for example, using a PROFILE SERIES cross-lapper commercially-available from ASSELIN-THIBEAU of Elbeuf sur Seine, 76504 France) or vertical (for example, using the STRUTO system from the University of Liberec, Czech Republic or the WAVE-MAKER system from Santex AG of Switzerland).

The oxidized polyacrylonitrile fibers can be present in any amount sufficient to provide the thermal insulator with the desired flame resistance and insulating properties. The oxidized polyacrylonitrile fibers can be present in an amount of from 60 wt % to 100 wt %, 70 wt % to 100 wt %, 81 wt % to 100 wt %, or in some embodiments, less than, equal to, or greater than 50 wt %, 55, 60, 65, 70, 75, 80, 85, 90, or 95 wt %, or less than or equal to 100 wt %.

In some embodiments, the non-woven core layer includes a multiplicity of fiber entanglements, where two or more discrete fibers become knotted or twisted together. The fibers within these entanglements, while not physically attached, can be so intertwined that they resist separation when pulled in opposite directions.

Entanglements can be induced by a needle tacking process or hydroentangling process. Advantageously, these processes can provide entanglements in which the fibers in the non-woven core layer are substantially entangled along directions perpendicular to the major surfaces of the non-woven core layer, thereby enhancing loft and increasing strength of the non-woven core layer along these directions.

The non-woven core layer can be entangled using a needle tacker commercially available under the trade designation DILO from Dilo of Germany, with barbed needles (commercially available, for example, from Foster Needle Company, Inc., of Manitowoc, Wis.) whereby the substantially entangled fibers described above are needle tacked fibers. Needle tacking, also referred to as needle punching, entangles the fibers perpendicular to the major surface of the non-woven core layer by repeatedly passing an array of barbed needles through the web and retracting them while pulling along fibers of the web.

The needle tacking process parameters, which include the type (or types) of needles used, penetration depth, and stroke speed, are not particularly restricted. Further, the optimum number of needle tacks per area of mat will vary depending on the application. Typically, the non-woven core layer is needle tacked to provide an average of at least 5 needle tacks/cm². Preferably, the mat is needle tacked to provide an average of about 5 to 60 needle tacks/cm², more preferably, an average of about 10 to about 20 needle tacks/cm².

Further options and advantages associated with needle tacking are described elsewhere, for example in U.S. Patent Publication Nos. 2006/0141918 (Rienke), 2011/0111163 (Bozouklian et al.), and International Patent Application No. PCT/CN2017/110372 (Cai et al.).

The non-woven core layer can also be hydroentangled using a conventional water entangling unit (commercially available from Honeycomb Systems Inc. of Bidderford, Me.; also see U.S. Pat. No. 4,880,168 (Randall, Jr.)). Although the preferred liquid to use with the hydroentangler is water, other suitable liquids may be used with or in place of the water.

In a water entanglement process, a pressurized liquid such as water is delivered in a curtain-like array onto a non-woven core layer, which passes beneath the liquid streams. The mat or web is supported by a wire screen, which acts as a conveyor belt. The mat feeds into the entangling unit on the wire screen conveyor beneath the jet orifices. The wire screen is selected depending upon the final desired appearance of the entangled mat. A coarse screen can produce a mat having perforations corresponding to the holes in the screen, while a very fine screen (e.g., 100 mesh) can produce a mat without the noticeable perforations.

In exemplary embodiments, the non-woven core layer has an average bulk density of from 5 kg/m³ to 200 kg/m³, 10 kg/m³ to 100 kg/m³ 15 kg/m³ to 50 kg/m³, 15 or 20 kg/m³ to 40 kg/m³, 20 kg/m³ to 30 or 40 kg/m³, or in some embodiments less than, equal to, or greater than 15 kg/m³, 16, 17, 18, 19, 20, 22, 24, 25, 26, 28, 30, 32, 35, 37, 40, 42, 45, 47, or 50 kg/m³.

### Reinforcing Fibers

Optionally, the non-woven core layer includes both a plurality of oxidized polyacrylonitrile fibers blended with a plurality of secondary fibers known as reinforcing fibers. In some embodiments, the scrim includes both a plurality of oxidized polyacrylonitrile fibers blended with a plurality of secondary fibers known as reinforcing fibers. The reinforcing fibers may include binder fibers, which have a sufficiently low melting temperature to allow subsequent melt processing of the non-woven core layer. Binder fibers are generally polymeric, and may have uniform composition or contain two or more components. In some embodiments, the binder fibers are bi-component fibers comprised of a core polymer that extends along the axis of the fibers and is surrounded by a cylindrical shell polymer. The shell polymer can have a melting temperature less than that of the core polymer.

As used herein, however, “melting” refers to a gradual transformation of the fibers or, in the case of a bi-component shell/core fiber, an outer surface of the fiber, at elevated temperatures at which the polyester becomes sufficiently soft and tacky to bond to other fibers with which it comes into contact, including non-meltable fibers and any other binder fibers having its same characteristics and, as described above, which may have a higher or lower melting temperature.

Certain thermoplastic materials such as polyester can become tacky when melted, making them suitable materials for the outer surface of a binder fiber. Useful binder fibers have outer surfaces comprised of a polymer having a melting temperature of from 100° C. to 300° C., or in some embodiments, less than, equal to, or greater than, 100° C., 105, 110, 115, 120, 125, 130, 135, 140, 145, 150, 160, 170, 180, 190, 200, 210, 220, 230, 240, 250, 260, 270, 280, 290, or 300° C.

Binder fibers increase structural integrity in the thermal insulator by creating a three-dimensional array of nodes where constituent fibers are physically attached to each other. These nodes provide a macroscopic fiber network, which increases tear strength, tensile modulus, preserves dimensional stability of the end product, and reduces fiber shedding. Advantageously, incorporation of binder fibers can allow bulk density to be reduced while preserving structural integrity of the non-woven core layer, which in turn decreases both weight and thermal conductivity.

The reinforcing fibers can have any suitable diameter to impart sufficient loft, compressibility, and/or tear resistance to the thermal insulator 100. The reinforcing fibers can have an average fiber diameter of from 10 micrometers to 1000 micrometers, 15 micrometers to 300 micrometers, 20 micrometers to 100 micrometers, or in some embodiments, less than, equal to, or greater than 10 micrometers, 15, 20, 25, 30, 35, 40, 45, 50, 60, 70, 80, 90, 100, 120, 150, 170, 200, 250, 300, 400, 500, 750, or 1000 micrometers.

The reinforcing fibers can be present in an amount of from 1 wt % to 40 wt %, 3 wt % to 30 wt %, 3 wt % to 19 wt %, or in some embodiments, equal to or greater than 0 wt %, or less than, equal to, or greater than 1 wt %, 2, 3, 4, 5, 7, 10, 15, 20, 25, 30, 35, 40, 45, or 50 wt %. In some embodiments, the reinforcing fibers are present in an amount from 5 wt % to 50 wt %, 10 wt % to 40 wt %, or 15 wt % to 30 wt % based on the overall weight of the non-woven core layer.

Preferred weight ratios of the oxidized polyacrylonitrile fibers to reinforcing fibers bestow both high tensile strength to tear resistance to the thermal insulator as well as acceptable flame retardancy—for instance, the ability to pass the UL-94V0 flame test. The weight ratio of oxidized polyacrylonitrile fibers to reinforcing fibers can be at least 4:1, at least 5:1, at least 10:1, or in some embodiments, less than, equal to, or greater than 4:1, 5:1, 6:1, 7:1, 8:1, 9:1, or 10:1.

By so reducing the overall effects of thermal conduction and convection, it is possible to achieve surprisingly low thermal conductivity coefficients. The non-woven core layer of the provided thermal insulators can display a thermal conductivity coefficient of less than 0.035 W/K-m, less than 0.033 W/K-m, less than 0.032 W/K-m, or in some embodiments, less than, equal to, or greater than 0.031 W/K-m, 0.032, 0.033, 0.034, or 0.035 W/K-m, at ambient conditions according to ASTM D1518-85 (re-approved 2003). Thermal conductivity coefficients in these ranges can be obtained with the non-woven core layer in its relaxed configuration (i.e., uncompressed) or compressed to 20% of its original thickness based on ASTM D5736-95 (re-approved 2001).

As a further option, it is possible that the non-woven core layer includes a plurality of fibers that are neither oxidized polyacrylonitrile fibers nor reinforcing fibers having an outer surface comprised of a polymer with a melting temperature of from 100° C. to 300° C. Such fibers may include, for example, polyester fibers having a melting temperature exceeding 300° C. To maximize the flame retardancy of the thermal insulator, however, it is preferred that the oxidized polyacrylonitrile fibers represent over 85 vol %, over 90 vol %, or over 95 vol % of the plurality of fibers that do not have an outer surface comprised of a polymer with a melting temperature of from 100° C. to 300° C.

Optionally, the oxidized polyacrylonitrile fibers and reinforcing fibers are each crimped to provide a crimped configuration (e.g., a zigzag, sinusoidal, or helical shape). Alternatively, some or all of the oxidized polyacrylonitrile fibers and reinforcing fibers have a linear configuration. The fraction of oxidized polyacrylonitrile fibers, 208 and/or reinforcing fibers that are crimped can be less than, equal to, or greater than 5%, 10, 15, 20, 25, 30, 40, 50, 60, 70, 80, 90, or 100%. Crimping, which is described in more detail in European Patent No. 0 714 248, can significantly increase the bulk, or volume per unit weight, of the non-woven core layer.

### Binders

The non-woven core layer optionally includes a binder to enable the edge sealing of the insulator. The binder is disposed on the scrims. The presence of the binder allows the peripheral edge of the scrim(s) to be edge sealed by melting at least part of the binder.

The binder can take many forms. In some embodiments, the binder of the non-woven core layer and/or scrims is provided through inclusion of binder fibers as described above. In other words, the scrim may optionally further comprises binder fibers. Useful binder fibers can include bicomponent fibers, including melty fibers, or monocomponent fibers. As an example, a suitable bicomponent fiber could include a polyester or nylon core with a low melting polyolefin sheath. As a further example, the bicomponent fiber could have a polyester core with a polyester-polyolefin copolymer sheath such as Type 254 CELBOND fiber provided by KoSa, Houston, Tex. This fiber has a sheath component with a melting temperature of approximately 230° F. (110° C.). The binder fibers can also be a polyester homopolymer or copolymer rather than a bi-component fiber.

Suitable monocomponent fibers include thermoplastic fibers with softening temperature less than 150° C. (such as polyolefin or nylon). Other suitable monocomponent fibers include thermoplastic fibers with softening temperature less than 260° C. (such as certain polyester fibers). For enhanced loft, it is beneficial for these binder fibers to be crimped, as mentioned above with respect to the reinforcing fibers.

Optionally, these binder fibers can also function as reinforcing fibers for the non-woven core layer. Alternatively, the binder fibers may be blended into the non-woven core layer as a separate component from the reinforcing fibers described in the previous section.

In other embodiments, the binder is provided by a coating. The coating is disposed on the scrims, and optionally the non-woven core layer. The coating can be applied to at least one major surface of the (e.g. fibers of the) scrim using any known method, such as solution casting or hot melt coating. Useful solution casting methods including brush, bar, roll, wiping, curtain, rotogravure, spray, or dip coating techniques.

The scrim may be orientated vertically or horizontally when the (e.g. aqueous) coating in applied.

In one embodiment, the method of making a flame retardant scrim comprises providing a scrim disposed on the release liner, the scrim having a first major surface in contact with the release liner, and an opposing major surface substantially parallel to the first major surface; applying an aqueous composition comprising a binder and flame retardant additive to the opposing major surface of the nonwoven scrim; and drying the aqueous flame retardant composition. The coated scrim is typically dried in an oven at 100° C. or higher (e.g. above the melting point of the organic polymer of the binder) such that the binder flow and forms a film on the surface of the fibers of the scrim.

This method is amenable to providing a scrim article further comprising a (e.g. removable) release liner. This facilitates handling the low basis weight scrims and utilizing the scrims for bonding to other materials, such as non-woven core layers. In some embodiments, the opposing major surface has a higher concentration of binder comprising flame retardant than the first major surface. In other embodiments, the first major surface has a higher concentration of binder comprising flame retardant than the opposing major surface.

Coatings effective in edge sealing the thermal insulator include those made from an acrylic polymer (e.g. latex) or polyurethane based (e.g. latex). Exemplary polymeric binders include Dow POLYCO 3103 (acrylic/vinyl acetate copolymer), Dow RHOPLEX HA-8, and DSM NEWREZ R-966 (polyurethane based latex). Such polymeric binders are non-fluorinated and typically non-halogenated. Other useful binder materials include fluorinated thermoplastics, optionally in the form of an aqueous emulsion, such as those provided under the trade designation THV and provided by 3M Company, St. Paul, Minn.

The binder can be non-ionic or ionic. In some embodiments, the binder is preferably non-ionic. In some embodiments, the aqueous latex binder has a pH less than 6.5 6, 5.5, 5, 4.5, 4, 3.5 or 3. In some embodiments, the aqueous binder has a formaldehyde content of less than 100, 10, or 1 ppm.

In some embodiments, the (e.g. acrylic or polyurethane polymer) binder has a glass transition temperature (Tg) ranging from −20° C. to 20° C. In some embodiments, the binder has a glass transition temperature (Tg) greater than −19° C., −18° C., 17° C., −16° C., −15° C. In some embodiments, the binder has a glass transition temperature (Tg) less than 15° C., 10° C., 5° C. or 0° C. The Tg can be determined by Differential Scanning calorimetry.

The latex can be cast onto the (e.g. fibers of the) scrims and optionally the non-woven core layer from an aqueous solution. The latex binder can be present in any suitable amount relative to the solids content of the aqueous solution. The latex binder can be present in an amount of from 1 wt % to 70 wt %, 3 wt % to 50 wt %, 5 wt % to 20 wt %, or in some embodiments, less than, equal to, or greater than 1 wt %, 2, 3, 4, 5, 7, 10, 12, 15, 17, 20, 25, 30, 35, 40, 45, 50, 55, 60, 65 or 70 wt % based on the overall solids weight of the coating.

In some embodiments, the aqueous binder coating composition comprises at least 5, 6, 7, 8, 9, or 10 wt. % binder. In some embodiments, the aqueous binder coating composition comprises no greater than 15, 20, 25, or 30 wt. % binder.

In some embodiments, the (e.g. acrylic or polyurethane) polymer binder is present in an amount of at least 10, 11, 12, 13, 14, 15, 16, 17, 18, 19 or 20 wt. % based on the overall solids weight of the coating. In some embodiments, the (e.g. acrylic or polyurethane polymer) binder is present in an amount no greater than 50, 45, 40, 35, or 30 wt. % based on the overall solids weight of the coating. In some embodiments, the (e.g. acrylic or polyurethane polymer) binder is present in an amount no greater than 29, 28, 27, 26, or 25 wt. % based on the overall solids weight of the coating.

The binder can also provide adhesion between the scrims and the non-woven core layer or other materials. This can be achieved by coating the binder onto inner surfaces of the scrim(s) before placing the scrims in contact with the non-woven core layer. Optionally, the binder can be spray coated onto these inner surfaces from solution.

In some embodiments, the coating should be sufficiently thick to form an edge seal that is generally uniform and void-free when the scrims, and optionally the non-woven core layer, are subjected to heat and/or pressure. The minimum coating weight for a given application would depend on the porosity and thickness of the scrims and non-woven core layer, among other factors.

In some exemplary embodiments, the coating has a basis weight of from 2 gsm to 100 gsm, from 5 gsm to 50 gsm, from 10 gsm to 20 gsm, or in some embodiments, less than, equal to, or greater than 2 gsm, 3, 4, 5, 7, 10, 12, 15, 17, 20, 25, 30, 35, 40, 45, 50, 55, 60, 65, 70, 75, 80, 85, 90, 95, or 100 gsm.

The amount of coating needed such that the scrim passes UL94 V0 Flame Test can vary depending on the coating composition (e.g. binder and char former) as well as the composition of the fibers of the scrim. In some embodiments, the dried coating has a basis weight of at least 10, 15, 20, 25, 30, 35, 40, 45, 50, 55, 60, 65, or 70 gsm. In other embodiments, the dried coating has a basis weight of at least 75 or 70 gsm. The amount of dried coating is typically no greater than 200, 190, 180, 170, 160, or 150 gsm. In some embodiments, the amount of dried coating is typically no greater than 200, 190, 180, 170, 160, or 150 gsm. In some embodiments, the amount of dried coating is typically no greater than 145, 140, 135, 130, 125, 120, 115, 110, 105 or 100 gsm.

It can be advantageous for the coating to contain other components in addition to the binder. For example, where the binder is not flame resistant, the coating can further include a flame retardant additive.

In some embodiments, the basis weight of the (e.g. dried) coating comprising flame retardant additive is at least 50 gsm in order to render a low basis weight (e.g. polypropylene) scrim passes UL94-V0 flammability standard. In some embodiments, the basis weight of the (e.g. dried) coating comprising flame retardant additive is no greater than 140, 130, 120, 110 or 100 gsm.

Flame tests conducted on these articles used to measure compliance with the UL94-V0 flammability standard revealed that thin sections in the thermal insulator are most vulnerable to burning. Further, edge sealing of the thermal insulator results in areas of reduced thickness. As a result, the addition of a flame retardant into the coating applied to edge sealed areas was found to have an especially significant effect in enhancing overall fire resistance. In certain embodiments, this modification enables the scrim alone, as well as the thermal insulator to pass the UL94-V0 flammability standard. Surprisingly, it was discovered that, in some embodiments, the multilayer thermal insulator as a whole can pass the UL94-V0 flammability standard, even when the non-woven core layer and the scrims individually cannot.

Useful flame retardant additives include phosphate-based additives, such as ammonium polyphosphate. Ammonium polyphosphate is an inorganic salt of polyphosphoric acid and ammonia, and may be either a linear or branched polymer. Its chemical formula is [NH₄PO₃]ₙ(OH)₂, where each monomer consists of an orthophosphate radical of a phosphorus atom with three oxygens and one negative charge neutralized by an ammonium cation leaving two bonds free to polymerize. In the branched cases some monomers are missing the ammonium anion and instead link to other monomers. Organophosphates other than ammonium polyphosphate can also be used.

The properties of ammonium polyphosphate depend on the number (“n”) of [NH₄PO₃] repeat units and degree of branching. In some embodiments, n is greater than 1000 and the ammonium polyphosphate has low solubility in water (maximum of 1% by weight as measured with gravimetry after filtration of a 10% aqueous suspension at 25° C.). In some embodiments, the ammonium polyphosphate has a particle having a (D50) average particle size of no greater than 50, 40, 30, 20 or 10 microns.

Other additives that can enhance fire resistance of the coating include intumescents, or substances that swell as a result of heat exposure. In the provided thermal insulators, an intumescent additive can include one or more of: (1) a phosphorus-containing part, provided for example by ammonium polyphosphate, (2) a hydroxyl-containing part that increases char in the event of a fire, such as sucrose, lignin, catechol, pentaerythritol (“PER”), and gallic acid, and (3) a nitrogen-containing part that can act as blowing agent, such as melamine or ammonium. In a preferred embodiment, components (1)-(3) are all used in combination. Intumescents can also include graphite filler, such as expandable graphite. Expandable graphite is a synthesized intercalation compound of graphite that expands when heated.

In some embodiments, sucrose and lignin, have been found to be particularly useful in combination with certain polymeric binders and ammonium polyphosphate flame retardant additives.

Sucrose is a disaccharide molecule, composed of two monssaccharides: glucose and fructose. Sucrose has the molecular formula C₁₂H₂₂O₁₁, depicted as follows:

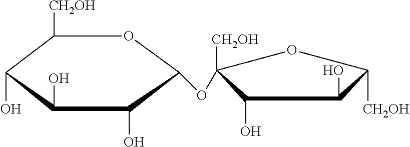

Lignin is a class of complex organic polymers that form key structural materials in the support tissues of vascular plants and some algae. Lignins are particularly important in the formation of cell walls, especially in wood and bark, because they lend rigidity and do not rot easily. Chemically, lignins are cross-linked phenolic polymers.

The lignols that crosslink are of three main types, all derived from phenylpropane: 4-hydroxy-3-methoxyphenylpropane, 3,5-dimethoxy-4-hydroxyphenylpropane, and 4-hydroxyphenylpropane (depicted as follows).

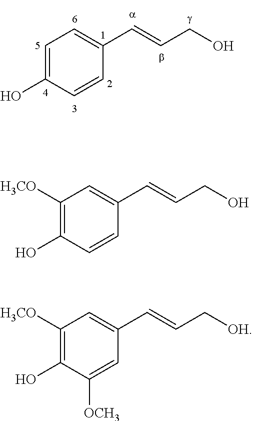 [SMILES: OC/C=C/c1ccc(O)cc1 ; COc1cc(/C=C/CO)ccc1O ; COc1cc(/C=C/CO)cc(OC)c1O]

The composition of lignin varies from species to species. For example, 4-hydroxyphenylpropane is more prevalent in hardwoods and the other types with methoxy substituents more prevalent in conifers.

Various structures of lignin have been described in the literature. One representative structure is as follows:

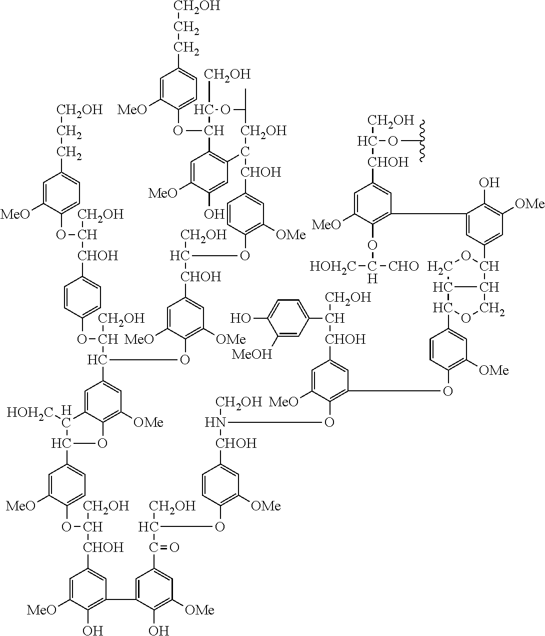

When lignin is removed from wood by sulfite pulping, the lignin may be characterized as sulfonated lignin. Sulfonation occurs at the side chains. Thus, the lignin structure comprises —SO₃⁻ M groups in place hydroxyl atoms on the (e.g. propyl) side chains, wherein M is a metal such as sodium. Sulfonated lignin is also known as lignosulfonate and more commonly kraft lignin.

Lignin and lignosulfonate can have various molecular weights. The molecular weight can range from 1000 to 140,000 daltons. Lignin and lignosulfonate are both water dispersible and are described in the literature as being water soluble.

Both sucrose and lignin include hydroxyl groups attached directly to an aliphatic or aromatic ring. Sucrose and lignin also contain —CH₂OH groups, or in other words primary alcohol groups. Lignin also contains other types of alcohol groups that may be categorized as secondary alcohol groups, having the formula “—CHROH” or tertiary alcohol groups having the formula “—CR₂OH”, where “R” indicates a carbon-containing group

The flame retardant additive can be dissolved or dispersed with the binder in a common solvent and both components solution cast onto the scrims and optionally the non-woven core layer. Conveniently, ammonium polyphosphate can be cast from an aqueous solution that also contains a polymer latex.

The flame retardant additive can be present in an amount of from 5 wt % to 95 wt %, from 10 wt % to 90 wt %, from 25 wt % to 75 wt %, from 20 wt % to 60 wt %, from 40 wt % to 60 wt % or in some embodiments, less than, equal to, or greater than 5 wt % 10, 15, 20, 25, 30, 35, 40, 45, 50, 55, 60, 65, 70, 75, 80, 85, 90, or 95 wt % based on the overall solids weight of the coating (i.e. binder, flame retardant additive, and optional materials including char forming material).

In typical embodiments, the concentration of flame retardant (e.g. ammonium polyphosphate) additive is equal to or greater than the concentration of (e.g. acrylic) polymer binder. The weight ratio of flame retardant (e.g. ammonium polyphosphate) additive to (e.g. acrylic) polymer binder is typically at least 0.1:1, 0.2:1, 0.3:1, 0.4:1, 0.5:1, 0.6:1, 0.7:1, 0.8:1, 0.9:1, 1:1, 1.5:1, 2:1, or 2.5:1. In some embodiments, the weight ratio of flame retardant (e.g. ammonium polyphosphate) additive to (e.g. acrylic) polymer binder is no greater than 5:1, 4.5:1, 4:1, 3.5:1, 3:1, or 2.5:1.

The components of the coating (e.g. binder, flame retardant additive, char former, other optional additives can be chosen such the coating is halogen free.

The aqueous solution itself can have any suitable concentration to provide an appropriate viscosity for the selected coating method, and provide for a uniform coating on the fibers of the scrims and optionally the non-woven core layer. For spray coating, it is typical to use a solids content of from 1 wt % to 50 wt %, from 2.5 wt % to 25 wt %, from 5 wt % to 15 wt %, or in some embodiments, less than, equal to, or greater than 1 wt %, 1.5, 2, 2.5, 3, 3.5, 4, 4.5, 5, 6, 7, 8, 9, 10, 12, 15, 17, 20, 25, 30, 35, 40, 45, or 50 wt %.

### Scrims

The scrims referred to in FIGS. 1-3 are not particularly restricted, and can include any type of open mesh structure that is either woven or non-woven. The scrims described herein also have utility in the absence of a non-woven core layer. For example, the scrims can be used for thermal insulation of apparel.

Woven scrims may have any type of weave, and non-woven scrims are produced using any well-known technique, including melt blowing, spun lace and spun bond techniques.

Non-woven scrims include those made from any of a broad variety of thermoplastic fibers including polyethylene fibers, polyolefin including polypropylene fibers, and mixtures of polyethylene and polypropylene fibers, nylon fibers (such as the nylons described above), polyester fibers (such as the polyesters described above and polylactic acid based polymers), acrylic and modacrylic fibers such as polyacrylonitrile fibers and acrylonitrile and vinylchloride copolymer fibers, polyphenylene sulfide fibers, polystyrene fibers, polyvinylacetate fibers, polyvinylchloride fibers, cellulose acetate fibers, glass fibers and viscose fibers. In combination with the above thermoplastic synthetic fibers there may also be used the natural fibers such as cotton or wool, as well as rayon, a manufactured fiber made from cellulose fiber.

In typical embodiments, the thermoplastic fibers of the non-woven scrim have a melt point less than 350° C. or 300° C., as measured according to Differential Scanning calorimetry (DSC). In some embodiments, the thermoplastic fibers of the nonwoven scrim have a melt point of at least 130, 140 or 150° C. In some embodiments, the melt point is at least 175, 200, 225 or 250° C.

In the provided thermal insulators, suitable polymeric fibers used to produce the scrim include for example polyamides, polyesters (including polylactic acid based polymers), and polyolefins, particularly polyethylene and polypropylene, or a combination thereof. The scrim may also contain fiberglass and/or oxidized polyacrylonitrile (OPAN) fibers. In some embodiments, the scrim comprises OPAN and a thermoplastic fiber, such as polyester or polyphenylene sulfide. The weight ratio of OPAN to thermoplastic fiber can range from 1:25 to 25:1. In some embodiments, the weight ratio of OPAN to thermoplastic fiber is at least 2:1, 3:1, 4:1, 5:1, 6:1, 7:1, 8:1, or 9:1.

In some embodiments, the open mesh fabric comprises at least one nylon, a high-density polyethylene or a combination thereof. In typical embodiments, the fibers of the scrim are not flame resistant fibers. Rather, the scrim is rendered flame resistant by further comprising a binder with a flame retardant additive disposed on at least a portion of the fibers of the scrim. Thus, in this embodiment, the fibers of the scrim do not include a flame retardant additive contained within the fiber material.

Alternatively, the scrim is composed of flame resistant fibers. While fiberglass fibers have better intrinsic fire resistance than the aforementioned polymers, even combustible polymers can be provided with significant fire resistance by blending with sufficient amounts of a flame retardant additive. For example, these scrims can be made from flame-resistant (e.g. polyester) fibers.

The flame retardant additive can be either miscible or immiscible with the host polymer. Miscible additives include polymer melt additives such as phosphorus-based flame retardants that contain phenolic end groups. Polyphosphonates, including polyphosphonate homopolymers and copolymers, can also be miscibly blended with polyesters to form flame-resistant fibers. Useful additives are commercially available under the trade designation NOFIA from FRX Polymers, Inc., Chelmsford, Mass. Generally, miscible additives are preferred in making scrims with fine fiber diameters. If fiber diameters are larger than 10 microns, then inclusion of certain immiscible salts could also be used to enhance fire resistance.

Flame resistant fibers can be, in some embodiments, capable of passing the UL94-V0 flammability standard when formed into a non-woven web made from 100% of such fibers, and having a base weight of less than 250, 225, 200, 175, or 150 gsm and web thickness of less than 6 millimeters.

The scrims are generally much thinner than the non-woven core layer of the previously described multilayer construction. To minimize the weight of the thermal insulator, the scrims can be made only as thick as necessary to serve the purpose of encapsulating loose fibers in the non-woven core layer while satisfying any technical requirements for strength and toughness.

In some embodiments, the scrim has a thickness of at least 0.05, 0.06, 0.07, 0.08, 0.09, or 0.1 mm. The thickness of the scrim is typically no greater than 1 mm. In some embodiments, the thickness of the scrim is no greater than 0.9, 0.8, 0.7, 0.6, 0.5 or 0.3 mm.

In a preferred embodiment, one or both scrims (i.e. prior to applying the binder with flame retardant additive) have a basis weight of from 10 gsm to 100 gsm, from 20 gsm to 80 gsm, from 30 gsm to 70 gsm, or in some embodiments, less than, equal to, or greater than 10 gsm, 12, 15, 17, 20, 25, 30, 35, 40, 45, 50, 55, 60, 65, 70, 75, 80, 85, 90, 95, or 100 gsm.

After applying the binder with the flame retardant additive, one or both of the coated scrims typically have a basis weight of at least 50 gsm and in some embodiments at least 60, 70, 80, 90 or 100 gsm, The coated scrims typically have a basis weight no greater than 200, 190, 180, 170, 160, or 150 gsm.

Further variants are possible. For example, the fibers in the non-woven core layer and/or scrim can be coated with other compositions that are not binders. The coating on the fibers can be selected from, for example, silicones, acrylates, and fluoropolymers whereby the non-woven core layer has an emissivity of less than 0.5. Here, “emissivity” is defined as the ratio of the energy radiated from a material's surface to that radiated from a blackbody (a perfect emitter) at the same temperature and wavelength and under the same viewing conditions. Reducing emissivity helps lower the extent to which a material loses heat from thermal radiation.

Coating the constituent fibers of the non-woven core layer can impart significant functional and/or aesthetic benefits. For example, coating the fibers has the effect of reinforcing the fibers, thus increasing the overall strength of the web. Certain coating materials, such as fluoropolymers and silicones, may enhance resistance to staining or fouling because of airborne substances becoming adhered to fiber surfaces. In some applications it can be desirable to sheath the fibers in an opaque coating, can also be used to change the color of the non-woven core layer, which would be generally be black or grey for oxidized polyacrylonitrile fibers or other carbonized fibers.

The non-woven core layers in FIGS. 1-3 can have any suitable thickness based on the space allocated for a given application. As a thermal insulator used in an electric vehicle compartment, the non-woven core layers can have a thickness of from 1 millimeter to 50 millimeters, from 2 millimeters to 25 millimeters, from 3 millimeters to 20 millimeters, or in some embodiments, less than, equal to, or greater than 1 millimeter, 2, 3, 4, 5, 6, 7, 8, 9, 10, 12, 15, 17, 20, 22, 25, 27, 30, 35, 40, 45, or 50 millimeters.

### Methods of Manufacture

The provided thermal insulators can be made in a variety of ways, including batch methods and continuous methods.

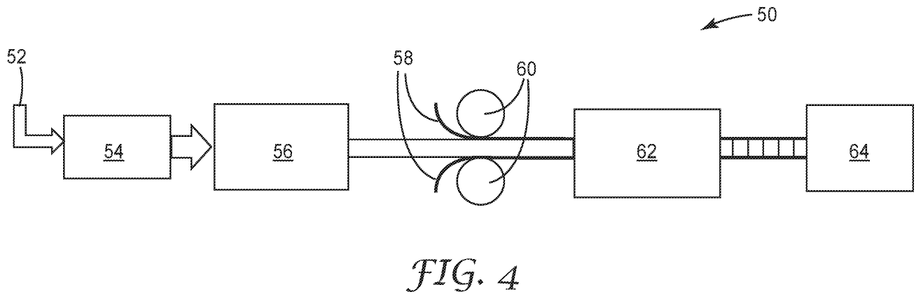

FIG. 4 is diagram of a workflow 50 that illustrates an exemplary continuous manufacturing method. The workflow begins with the material inputs represented by block arrow 52, which feed into a carding process represented by block 54.

Material inputs include non-meltable polymeric fibers of the non-woven core layer, such as OPAN fibers. The non-meltable fibers can be blended with optional reinforcing fibers and/or binder fibers, such as a high temperature polyester fiber. In an exemplary process, OPAN fibers are blended with a high temperature polyethylene terephthalate staple fiber and carded to form a non-woven core layer having a thickness of about 8 mm.

Referring again to FIG. 4, the top and bottom major surfaces of the web are then spray coated with a binder solution in block 56. Dispersed in the solution is a polymeric binder and optionally a soluble flame retardant additive to improve the fire resistance of the coating. Based on environmental, health, and safety factors, it can be advantageous to use an aqueous binder solution, and avoid the need for volatile organic solvents. In alternative embodiments, the spray coating is applied only to the top or only to the bottom major surface of the web.

The spray coating step of block 56 can result in the binder solution penetrating deeply into the non-woven core layer, depending on the spraying technique, size of the spray droplets and thickness of the layer. In some embodiments, the depth of penetration is 100%, or greater than, equal to, or less than 95%, 90, 85, 80, 75, 70, 65, 60, 55, or 50%, relative to the thickness of the non-woven core layer.

The coated web can then be guided between scrims 58, 58 and all three layers conveyed between nip rolls 60, 60. When the layers come together, the binder solution may penetrate slightly into one or both scrims, and thus provide some degree of adhesion when the coating is dried. It can be advantageous for the binder solution not to completely penetrate through either scrim, since this could cause the outer surface of the thermal insulator to stick to tooling when edge sealed.

In block 62, the scrims and coated non-woven core layer are subjected to an entangling process. The entangling process can be, for example, a needle tacking or hydroentangling process. The output of this process step is a multilayered construction where the fibers of the scrims and the core layer are substantially entangled with each other along directions perpendicular to a major surface of the non-woven core layer.

Finally, in block 64, the coated and entangled web is heated in an oven to dry the coated fibers. Preferably, this step removes substantially all residual solvent introduced into the web from the fiber coating process in block 56. The end product of this workflow is an open-edged thermal insulator that can be stored in roll form and is capable of being edge sealed by a converter or end user.

Optionally, entangling step of block 62 can take place at another stage of the workflow 50. For example, this step can be take place immediately before the spray coating step of block 56 so that the binder solution does not contaminate the barbed needles used in needle tacking. A disadvantage of this modified workflow is that only the core layer will be entangled rather than all three layers. As another possibility, the entangling step of block 62 can be moved later so that it occurs after the drying step of block 64. By drying the web prior to entanglement, the problem of needle contamination can also be mitigated.

In an alternative method, the top and bottom major surfaces of the (nonwoven core layer) web are not spray coated with a binder solution in block 56. Rather, the (nonwoven core layer) web is guided between scrims 58, 58 wherein scrims disposed on a release liner were coated with an aqueous flame retardant composition as described herein, and dried thereby providing scrims 58, 58 disposed on a release liner. The scrims are then contacted with the (non-woven core layer) web and conveyed between nip rolls 60, 60. The release liners are then removed from the scrims prior to the entangling step of block 62.

Edge sealing can be achieved using any number of useful methods. One method involves direct application of heat and pressure simultaneously by placing the open-edged thermal insulator in contact with a tool having one or more heated surfaces. In some embodiments, the surfaces are metal tool surfaces.

Instead of using a heated tool, it is possible to heat one or both major surfaces of the open-edged thermal insulator immediately prior to pressing it between unheated tool surfaces to edge seal the insulator. Such heat can be imparted by heated air (e.g., by convective heating) or by exposure to light (e.g., radiative heating). In some embodiments, the scrim surfaces are joined together using ultrasonic heating.

After edge sealing, it is generally desirable for the sealed thermal insulator to be cleanly removable from the tool surfaces. Clean removal can be facilitated by judicious selection of the binder. To avoid sticking issues, it is preferred that the softening temperature (e.g., T_{g}) of the binder is well below the softening point of the scrim. If the scrim is made from a semi-crystalline polymer such as a polyester, this softening temperature can correspond to its melting temperature.

Using an edge seal temperature well below the melting temperature of the scrim also helps avoid inducement of brittleness in the scrim that can result from melting and re-crystallization in the fiber polymer.

To further improve the quality of the release, the outer surface of the scrims may be treated with a silicone.

While not intended to be limiting, some embodiments are enumerated as follows:

A method of making a flame retardant scrim comprising:

providing a scrim having a basis weight less than or equal to 100 grams/m² disposed on a release liner having a first major surface in contact with the release liner, and an opposing major surface substantially parallel to the first major surface;
applying an aqueous composition comprising a binder and flame retardant additive to the opposing major surface of the nonwoven scrim;
drying the aqueous flame retardant composition.

The method wherein the aqueous composition has a pH of less than 3.5.

The method wherein the scrim is further characterized according to the claims.

A method of making a thermal insulator providing the scrim disposed on a release liner as claimed;

applying the opposing major surface of the nonwoven web to first and second major surfaces of a nonwoven core layer;
removing the release liner; and
edge sealing the peripheral edges of the nonwoven web.

The method of making a thermal insulator wherein the peripheral edge is welded with pressure, heat, or a combination thereof.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE 1
Materials

| Designation | Description | Source |
|---|---|---|
| OPAN 1 | Oxidized polyacrylonitrile | Zoltek ™ Corporation (wholly |
| | staple fibers, 1.7 dTex | owned subsidiary of Toray |
| | available under the trade | Group), Bridgeton, MO |
| | designation “OX” | |
| OPAN 2 | Oxidized polyacrylonitrile | Suzhou LONGBANG |
| | staple fibers, 1.2 dTex | Polymer Fiber Co., Ltd., |
| | | Jiangsu, China |
| TREVIRA 270 | A flame retardant polyethylene | Trevira GmbH, Hattersheim, |
| | terephthalate staple fiber, 6.5 | Germany |
| | dTex, available under the trade | |
| | designation “TREVIRA 270” | |
| TREVIRA 276 | A flame retardant bicomponent | Trevira GmbH, Hattersheim, |
| | staple fiber of copolyolefin, 3.3 | Germany |
| | dTex, available under the trade | |
| | designation “TREVIRA 276” | |
| FR PET Scrim | A flame retardant polyethylene | Precision Fabrics Group, Inc., |
| | terephthalate scrim material | Greensboro, NC |
| | (70% PET and 30% Rayon), | |
| | 50 gsm, 0.33 mm | |
| FR PET Scrim with | A flame retardant polyethylene | Precision Fabrics Group, Inc., |
| Adhesive | terephthalate scrim material | Greensboro, NC |
| | (70% PET and 30% Rayon) | |
| | with a heat activated adhesive | |
| | on one side, 70 gsm | |
| White PET Scrim | White polyester scrim: 16 gsm | HDK Industries Inc, |
| | base weight, 3-mil thickness | Rogersville, TN |
| | (0.075 mm) | |
| PET-FW Scrim | Polyester, spunbond, 40 gsm | Fiberweb, Old Hickory, TN |
| | basis weight, obtained under | |
| | the trade designation | |
| | “REEMAY 2100”, 0.28 mm | |
| | thickness, | |
| PP Scrim | Polypropylene, spunbond, 15 | Berry Global, Evansville, IN |
| | gsm basis weight, 0.1 mm | |
| | thickness | |
| PLLA | Polylactic acid polymer scrim, | Berry Global, Evansville, IN |
| | 35 gsm basis weight, 0.23 mm | |
| | thickness | |
| B-15J | A spray coating formula | Dow Chemical, Midland, MI |
| | including an acrylic latex | |
| | binder, 5 wt. % solids, available | |
| | under the trade designation | |
| | “RHOPLEX B-15J” | |
| HA-8 | Self-crosslinking aqueous | Dow Chemical, Midland, MI |
| | acrylic emulsion available | |
| | under the trade designation | |
| | “RHOPLEX HA-8”, | |
| | 45.5 wt. % solids | |
| ST954 | Conventional self-crosslinking | Dow Chemical, Midland, MI |
| | acrylic binder available under | |
| | the trade designation | |
| | “RHOPLEX ST954”, 45.5 | |
| | wt. % solids | |
| AP420 | A water-based short chain | Clariant Corp., Minneapolis, |
| | ammonium polyphosphate | MN |
| | flame retardant additive | |
| | available under the trade | |
| | designation “EXOLIT AP 420” | |
| AP423 | A long-chain ammonium | Clariant Corp., Minneapolis, |
| | polyphosphate flame retardant | MN |
| | additive, available under the | |
| | trade designation “EXOLIT | |
| | AP 423” | |
| SMC 688 | Cyclic phosphonate flame | Special Materials Company, |
| | retardant available under the | New York, NY |
| | trade designation “SMC 688” | |
| FR CROS 634 | Water-based short chain | Budenheim, Budenheim, |
| | ammonium polyphosphate | Germany |
| | available under the trade | |
| | designation “FR CROS 634” | |
| Melamine | Melamine available under the | OCI Nitrogen, Geleen, |
| | trade designation | Netherlands |
| | “MELAMINEBYOCI” | |
| EG249 | Expandable graphite flame | NYACOL, Ashland, MA |
| | retardant available under the | |
| | trade designation | |
| | “NYAGRAPH 249” | |
| AC-3 | Phosphate based halogen free | Broadview Technologies, |
| | fire retardant intumescent | Newark, NJ |
| | agent available under the trade | |
| | designation “INTUMAX AC- | |
| | 3” | |
| Sucrose | Sucrose, 99% | Alfa Aesar, Ward Hill, MA |
| | | and Sigma Aldrich, St. Louis, |
| | | MO |
| Catechol | 1,2 dihydroxybenzene, 99% | Alfa Aesar, Ward Hill, MA |
| PER | Pentaerythritol, 98% | Alfa Aesar, Ward Hill, MA |
| | | and Sigma Aldrich, St. Louis, |
| | | MO |
| Gallic Acid | S-Allyl-L-cysteine | Sigma Aldrich, St. Louis, MO |
| Lignin | Lignin, alkali (solid) | Sigma Aldrich, St. Louis, MO |
| THV 340Z | Fluoropolymer resin in | 3M Company, Saint Paul, |
| | emulsion; 50% weight in water | MN |
| | in solid content | |
| PPS 1 | Polyphenylene sulfide, 5.5 | Toray Industries, Inc., Tokyo, |
| | fiber denier, obtained under the | Japan |
| | trade designation “TICONA | |
| | PPS” | |
| PPS 2 | Polyphenylene sulfide, 2.7 | EMS-GRILTECH, |
| | fiber denier, obtained under the | Domat/Ems, Switzerland |
| | trade designation “NEXLYNE | |
| | S970 PPS” | |
| FR-PET | Flame retardant polyethylene | Trevira, Bobingen, Germany |
| | terephthalate obtained under | |
| | the trade designation | |
| | “TREVIRA FR-PET” | |

### Test Methods

Surface Base Weight measurement: A section of nonwoven web was cut to 30.5 cm by 30.5 cm (12 inch by 12 inch) and was weighed. The weight, in grams, of the section divided by the surface area (0.0929 m²) gave the surface base weight, reported in grams per square meter (“gsm”).
Nonwoven Web Thickness Measurement: The method of ASTM D5736-95 was followed, according to test method for thickness of high loft nonwoven fabrics. The plate pressure was calibrated at 0.002 psi (13.790 Pascal).
Flame Test: FAR 25-853a and FAR 25-853b vertical burner. Reference to UL94-V0 standard with flame height 20-mm, bottom edge of the sample 10-mm into the flame and burn twice at 10 seconds each. A flame propagation height under 125-mm (5 inches) was considered a pass.

### Preparatory Core Web Example 1

50-mm cut length 80% (by weight) OPAN 2 and 20% (by weight) TREVIRA 276 staple fibers were carded by passing the fibers through a Wave-Maker system from Santex AG to form a 150 gsm core web. The sample was oven activated at 150° C. to melt the high-temperature polyester fibers to bond the OPAN fibers, while maintaining the core web thickness at 6-mm. The sample underwent flame testing and the result is represented in Table 2.

### Preparatory Core Web Example 2

50-mm cut length 80% (by weight) OPAN 2 and 20% (by weight) TREVIRA 276 staple fibers were carded by passing the fibers through a Wave-Maker system from Santex AG to form a 150 gsm core web. The core web was then conveyed to a Dilo Needle Loom, Model DI-LOOM OD-1 6 from Eberbach, Germany having a needleboard array of 23 rows of 75 needles/row where the rows are slightly offset to randomize the pattern. The needles were Foster 20 3-22-1.5B needles. The array was roughly 17.8 cm (7 inches) deep in the machine direction and nominally 61 cm (24 inches) wide with needle spacings of roughly 7.6-mm (0.30 inch). The needleboard was operated at 91 strokes/minute to entangle and compact the web to a roughly 5.1-mm (0.20 inch) thickness. The sample underwent flame testing and the result is represented in Table 2.

### Preparatory Core Web Example 3

50-mm cut length 80% (by weight) OPAN 1 and 20% (by weight) TREVIRA 270 staple fibers were carded were carded by passing the fibers through a Wave-Maker system from Santex AG to form a 100 gsm, 8-mm core web. The sample was oven activated at 250° C. by a Desptach drying oven from Despatch of Minneapolis, Minn. to melt the high-temperature polyester fibers to bond the OPAN fibers, while maintaining the core web thickness at 8-mm. The sample underwent flame testing and the result is represented in Table 2.

### Preparatory Core Web Example 4

50-mm cut length 80% (by weight) OPAN 1 and 20% (by weight) TREVIRA 270 staple fibers were carded by passing the fibers through a Wave-Maker system from Santex AG to form a 100 gsm, 8-mm web. The web was then needle tacked by a Dilo Needle Loom, Model DI-LOOM OD-1 6. The sample underwent flame testing and the result is represented in Table 2.

TABLE 2
Flame Test Results

| Description | Result of Flame Test |
|---|---|
| Preparatory Example 1 | Fail |
| Preparatory Example 2 | Fail |
| Preparatory Example 3 | Pass |
| Preparatory Example 4 | Pass |
| Example 1 | Pass |
| Example 2 | Pass |
| Example 3 | Pass |
| Example 4 | Pass |
| Example 5 | Pass |
| Example 6 | Pass |
| Example 7 | Fail |
| Example 8 | Fail |
| Example 9 | Fail |
| Example 10 | Fail |
| Example 11 | Pass |
| Example 12 | Pass |
| Example 13 | Pass |
| Example 14 | Fail |
| Example 15 | Pass |
| Example 16 | Pass |
| Example 17 | Pass |
| Example 18 | Pass |
| Example 19 | Pass |
| Example 20 | Pass |
| Example 21 | Pass |
| Example 22 | Pass |
| Example 23 | Pass |
| Example 24 | Pass |
| Example 25 | Pass |
| Example 26 | Pass |
| Comparative Example 1 | Fail |
| Comparative Example 2 | Fail |
| Comparative Example 3 | Fail |
| Comparative Example 4 | Fail |

### Examples 1 and 2

FR PET Scrims were placed on both sides of the core webs created from Preparatory Example 1. The core webs were quilted via needle tack by hand. The samples underwent flame testing and the results are represented in Table 2.

### Examples 3 and 4

FR PET Scrims were placed on both sides of core web samples created in Preparatory Examples 3 and 4. The core webs were quilted via needle tack by hand. The samples underwent flame testing and the results are represented in Table 2.

### Examples 5 and 6

FR PET Scrims with Adhesive were placed on both sides of core web samples created in Preparatory Examples 3 and 4. The core webs were quilted via needle tack by hand. The samples underwent flame testing and the results are represented in Table 2.

### Examples 7 and 8

Using samples created in Examples 1 and 2, the edges were sealed using a PHI Model 0238-H hot press by placing the web between two 10.2 cm by 17.8 cm (4 inch by 7 inch) aluminum plates. The edges of the web were hot pressed to a thickness of 0.6-mm at 150° C. (302° F.) and 2.7 MPa for 2.5 minutes. The samples underwent flame testing and the results are represented in Table 2.

### Examples 9 and 10

Core webs from Preparatory Examples 3 and 4 were die cut to a 27.9 cm×27.9 cm (11 in ×11 in) square using an Atom SE231 press and knife cutter from MS (Manufacturers Supplies Co.) of Springfield, N.H. Two FR PET Scrims with adhesive were die cut to a 30.5 cm×30.5 cm (12 in ×12 in square). The FR PET Scrims were then stacked above and below the core web with 1.3 cm (0.5 in) of the scrim overlapping the core web on all four sides and the adhesive layer facing the core. The edges of the samples were then hot pressed by a PHI Model 0238-hot press and sealed by placing the samples between aluminum plates that matched the converted scrim size (27.9 cm×27.9 cm (11 in ×11 in)). The edges of the web were hot pressed to a thickness of 0.2-mm at 140° C. (280° F.) and 2.7 MPa for 2.5 minutes. The samples underwent flame testing and the results are represented in Table 2.

### Examples 11 and 12

The edges of the samples created in Examples 3 and 4 were dipped into a 10% solid content THV formulation. The formulation was made by mixing one-part of THV340z at 50% solid content with four parts of water to make 10% solid content. The samples were then placed into a 150° C. Despatch drying oven from Despatch of Minneapolis, Minn. for three minutes to dry. The samples underwent flame testing and the results are represented in Table 2.

### Example 13

A powder spray gun obtained from ECOSS Inc (through Amazon.com), of Tampa, Fla. was used to spray a 5% a coating of solid content THV 340Z onto the top and bottom of the core web created in Preparatory Example 3. The formulation was made by mixing one-part THV340Z at 50% solid content with nine (9) parts of water to make 5% solid content. The sample was placed into a 150° C. Despatch drying oven from Despatch of Minneapolis, Minn. for five minutes to dry. The sample underwent flame testing and the result is represented in Table 2.

### Example 14

A powder spray gun obtained from ECOSS Inc (through Amazon.com), of Tampa, Fla. was used to spray a coating of 5% solid content B-15J onto top and bottom of the core web created by Preparatory Example 3. The formulation was made by mixing one-part B-15J at 50% solid content with nine (9) parts of water to make 5% solid content. The sample was placed into a 150° C. Despatch drying oven from Despatch of Minneapolis, Minn. for three minutes to dry. The sample underwent flame testing and the result is represented in Table 2.

### Example 15

A core web was created by Preparatory Example 3. 5% B-15J was mixed with 10% AP420 using a DAC150 speed mixer from FlackTek Inc of Landrum, S.C. to create a 300 gsm mixture (with 5% B15 and 10% AP420). The mixture was sprayed onto the core web using a powder spray gun obtained from ECOSS Inc (through Amazon.com), of Tampa, onto the top and bottom of the core web resulting in a surface. Two FR PET Scrims were placed on the top and bottom layers of the core web. The sample was placed into a 150° C. Despatch drying oven from Despatch of Minneapolis, Minn. for five minutes to dry. The web was then passed needle tacked by a Dilo Needle Loom, Model DI-LOOM OD-1 6. The edges were sealed using a PHI Model 0238-H hot press by placing the web between two 10.2 cm by 17.8 cm (4 inch by 7 inch) aluminum plates. The edges of the web were hot pressed to a thickness of 0.6-mm at 171° C. (340° F.) and 2.7 MPa for 2.5 minutes. The sample underwent flame testing and the result is represented in Table 2.

### Example 16

A core web was created by Preparatory Example 3. 5% B-15J was mixed with 10% AP420 using a DAC150 speed mixer from FlackTek Inc of Landrum, S.C. to create a 300 gsm mixture (with 5% B15 and 10% AP420). The mixture was sprayed onto the core web using a powder spray gun obtained from ECOSS Inc (through Amazon.com), of Tampa, onto the top and bottom of the core web resulting in a surface. Two White PET Scrims were applied by nip rolling over the coatings on the top and bottom of the core web. The sample was placed into a 150° C. Despatch drying oven from Despatch of Minneapolis, Minn. for five minutes to dry. The web was then passed needle tacked by a Dilo Needle Loom, Model DI-LOOM OD-1 6. The edges were sealed using a PHI Model 0238-H hot press by placing the web between two 10.2 cm by 17.8 cm (4 inch by 7 inch) aluminum plates. The edges of the web were hot pressed to a thickness of 0.4-mm at 171° C. (340° F.) and 2.7 MPa for 2.5 minutes. The edges of the web were hot pressed to a thickness of 0.4-mm at 171° C. (340° F.) and 10.8 MPa for 2.5 minutes. The sample underwent flame testing and the result is represented in Table 2.

### Examples 17-26 and Comparative Examples 1-4

Core webs were created by Preparatory Example 3. Two White PET Scrims were placed on the top and bottom layers of each of the core webs. Formulations represented in Table 3 were spray coated onto the White PET Scrims. Coatings were applied using a powder spray gun obtained from ECOSS Inc (through Amazon.com), of Tampa, Fla. The formulas were mixed (prior to being applied) with a DAC150 speed mixer from FlackTek Inc of Landrum, S.C. In Examples 21, 22, and 24 only, the edges were sealed using a PHI Model 0238-H hot press by placing the web between two 10.2 cm by 17.8 cm (4 inch by 7 inch) aluminum plates. The edges of the web were hot pressed to a thickness of 0.4-mm at 171° C. (340° F.) and 2.7 MPa for 2.5 minutes. Otherwise, the White PET Scrims were clipped to the core webs. The samples underwent flame testing and the results are represented in Table 2.

TABLE 3
Coating Formulations

| Description | Composition | Weight (grams) |
|---|---|---|
| Example 17 | AP 420 | 40 |
| | Water | 40 |
| | PER | 9.6 |
| Example 18 | FR CROS 634 | 80 |
| | Water | 80 |
| | Sucrose | 20 |
| Example 19 | AP 420 | 80 |
| | Water | 80 |
| | Catechol | 10 |
| | Melamine | 0.5 |
| Example 20 | Water | 4 |
| | SMC 688 | 1 |
| Example 21 | FR CROS 634 | 12 |
| | Sucrose | 4 |
| | HA-8 | 0.5 |
| | Water | 20 |
| Example 22 | AP 420 | 12 |
| | Sucrose | 4 |
| | HA-8 | 0.5 |
| | Water | 20 |
| Example 23 | AP 423 | 8 (52.7 wt. % |
| | | solids after drying) |
| | Sucrose | 4 (26.3 wt. % |
| | | solids after drying) |
| | HA-8 | 7 (X 0.455 = 3.185 g, 21 wt. % |
| | | solids after drying) |
| | Water | 20 |
| Example 24 | HA-8 | 5 |
| | EG249 | 1 |
| Example 25 | AP 423 | 8 |
| | Gallic Acid | 4 |
| | HA-8 | 7 |
| | Water | 20 |
| Example 26 | AP 423 | 8 (52.7 wt. % |
| | | solids after drying) |
| | Lignin | 4 (26.3 wt. % |
| | | solids after drying) |
| | HA-8 | 7 (X 0.455 = 3.185 g, 21 wt. % |
| | | solids after drying) |
| | Water | 20 |
| Comparative | AC-3 | 8 |
| Example 1 | Sucrose | 4 |
| | HA-8 | 7 |
| | Water | 20 |
| Comparative | AP 423 | 4 |
| Example 2 | Sucrose | 3 |
| | HA-8 | 7 |
| | Water | 20 |
| Comparative | AP 423 | 8 |
| Example 3 | Sucrose | 4 |
| | B-15J | 7 |
| | Water | 20 |
| Comparative | AP 423 | 8 |
| Example 4 | Sucrose | 4 |
| | ST954 | 7 |
| | Water | 20 |

Coating formulations were applied to scrim materials using two methods. The first method utilized placing the scrim on a polyester release liner (obtained under the trade designation “HOSTAPHAN 215KN” from Mitsubishi Polyester Film, Inc., Greer, S.C.,) while oriented horizontally and then spray coating formulations of Table 3 onto the top major surface of the scrim (i.e. the major surface not in contact with the polyester release liner). A Mayer rod (grid 23) was used to squeeze out excess liquid from the scrim by drawing the rod across the scrim using slight pressure. For the second method, the spray coating formulations were applied to the scrim while oriented vertically. The coated scrim (along with the release liner in the case of the first method), were placed inside an oven and dried at 100° C. for 2 minutes.

The coated scrim was tested according to the UL94 V0 Flame Test, a standard for safety for flammability of plastic materials. A methane flame that is 20 mm high is applied twice for 10 seconds each. Samples that pass meet the following criteria

(1) flame self-extinguishes in less than 10 seconds after each application;

(2) does not drip and ignite the cotton underneath; and

(3) does not burn to the top (the 5 inch (125 mm) mark))

Scrims made using OPAN fibers and PPS or FR-PET fibers using the following procedure. The fibers were opened using fiber opening equipment (Micro Tuft Opener Model No. BE 080-134 553 obtained from Hergeth Hollingsworth). The opened OPAN fibers and PPS or FR-PET fibers were subsequently blended together at the weight ratio and final basis weight according to the following table using carding equipment (Model No. WZM/K5-d2-R2 obtained from Hergeth Hollingsworth). The fiber blends of OPAN and PPS or FR-PET were then carded into a unbonded web. The resulting fiber blended webs were passed through a calendaring set-up to apply heat (400° F. (204° C.)) and pressure (158 pounds per square inch (psi)) for web bonding purposes.

OPAN Based Scrim Properties

| FIBER COMPOSITION | FINAL BASIS WEIGHT, gsm |
|---|---|
| OPAN 1/PPS 1 = 4:1 | 35 |
| OPAN 1/PPS 1 = 9:1 | 35 |
| OPAN 1/PPS 1 = 9.5/0.5 | 35 |
| OPAN 1/PPS 2 = 9:1 | 30 |
| OPAN 1/FR-PET = 4:1 | 35 |

The OPAN based scrims were coated with the coating of Ex. 23. The coated scrim was tested according to the UL94 V0 Flame Test, a standard for safety for flammability of plastic materials.

TABLE 4
UL94 V0 Test Results of Coated Scrims

| | | BASIS WEIGHT | | BASIS WEIGHT | |
|---|---|---|---|---|---|
| | | OF UNCOATED | | OF DRIED | |
| | SCRIM | SCRIM, | Coating of | COATING, | |
| EX. | TYPE | gsm | Table 3 | gsm | UL94 V0 |
| Comparative | PET-FW | 40 | No Coating | | Fail |
| Ex. 5 | | | | | |
| Comparative | PP | 15 | No Coating | | Fail |
| Ex. 6 | | | | | |
| Comparative | PPLA | 35 | No Coating | | Fail |
| Ex. 7 | | | | | |
| Comparative | FR PET SCRIM | 50 | No Coating | | Fail |
| Ex. 8 | | | | | |
| EX-27 | PET-FW | 40 | Ex. 23 | 60 | Pass |
| EX-28 | PP | 15 | Ex. 23 | 70 | Pass |
| Comparative | PP | 15 | Ex. 23 | 47 | Fail |
| Ex. 10 | | | | | |
| EX-29 | PLLA | 35 | Ex. 23 | 54 | Pass |
| EX-30 | FR PET SCRIM | 50 | Ex. 23 | 62 | Pass |
| EX-31 | PET-FW | 40 | Ex. 26 | 73 | Pass |
| EX-32 | PET-FW | 40 | Ex. 23* | 75 | Pass |
| EX-33 | PET-FW | 40 | Ex. 21 | 97 | Pass |
| EX-34 | PET-FW | 40 | Ex. 22 | 99 | Pass |
| EX-35 | PET-FW | 40 | Comparative | 81 | Pass |
| | | | Example 3** | | |
| Comparative | PET-FW | 37 | Ex. 25 | 87 and | Fail |
| Ex. 9 | | | (Gallic acid | 124 | |
| | | | char former) | | |
| EX-36 | OPAN 1/ | 30 | Ex. 23 | 105 | Pass |
| | PPS 1 = 4:1 | | | | |
| Comparative | OPAN 1/ | 30 | No Coating | | Fail |
| Ex. 11 | PPS 1 = 4:1 | | | | |
| EX-37 | OPAN 1/ | 35 | Ex. 23 | 105 | Pass |
| | FR-PET = 4:1 | | | | |
| Comparative | OPAN 1/ | 35 | No Coating | | Fail |
| Ex. 12 | FR-PET = 4:1 | | | | |
| EX-38 | OPAN 1/ | 30 | Ex. 23 | 105 | Pass |
| | PPS 1 = 95/5 | | | | |
| Comparative | OPAN 1/ | 30 | No Coating | | Fail |
| Ex-13 | PPS 1 = 95/5 | | | | |
| EX-39 | OPAN 1/ | 30 | Ex. 23 | 105 | Pass |
| | PPS 2 = 9:1 | | | | |
| Comparative | OPAN 1/ | 30 | No Coating | | Fail |
| Ex. 14 | PPS 2 = 9:1 | | | | |

EX. 23* - Ex. 23 with 1 g of melamine added.
**EX-35 utilized a higher basis weight of coating than the scrim of the Flame Test Results reports for Comparative Example 3 in Table 2.

The basis weight of the coated scrim is the sum of the basis weight of uncoated scrim and the basis weight of the dried coating.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A scrim comprising a plurality of thermoplastic fibers having a melting point less than 350° C. and a coating disposed on the scrim; wherein the coating comprises a non-fluorinated binder and a flame retardant additive; and wherein the scrim has a basis weight less than or equal to 250 grams/m² and passes the UL94-V0 flammability standard.

2. The scrim of claim 1 wherein the plurality of fibers comprise at least one thermoplastic polymer selected from polyester, polyolefin, polyphenylene sulfide, and polylactic acid polymer.

3. The scrim of claim 2 wherein the plurality of fibers comprise polypropylene.

4. The scrim of claim 1 wherein the plurality of fibers is a nonwoven.

5. The scrim of claim 1 wherein the plurality of fibers has a basis weight ranging from 5 to 100 grams/m².

6. The scrim of claim 1 wherein the binder comprising the flame retardant additive has a basis weight of at least 50 grams/m².

7. The scrim of claim 5 wherein the basis weight of the plurality of fibers is less than the basis weight of the binder comprising the flame retardant additive.

8. The scrim of claim 1 wherein the binder comprises a polymer latex.

9. The scrim of claim 1 wherein the binder comprises an acrylic polymer.

10. The scrim of claim 1 wherein the binder has a glass transition temperature (Tg) ranging from −20° C. to 20° C.

11. (canceled)

12. The scrim of claim 1 wherein the flame retardant additive comprises ammonium polyphosphate.

13. The scrim of claim 1 wherein the binder further comprises a char forming material.

14. (canceled)

15. The scrim of claim 1 wherein the coating is halogen free.

16. A scrim article comprising a plurality of fibers and a coating disposed on the scrim wherein the coating comprises a binder and a flame retardant additive; wherein the scrim is disposed on a release liner and passes the UL94-V0 flammability standard.

17. The scrim article of claim 16 wherein the plurality of fiber have a melting point less than 350° C.

18. The scrim article of claim 16 wherein the scrim has basis weight less than or equal to 150 gsm.

19-21. (canceled)

22. A multilayer thermal insulator comprising: a non-woven core layer comprising non-meltable, flame-resistant polymeric fibers; and one or more scrims according to claim 1 disposed on opposing major surfaces of the non-woven core layer, wherein a peripheral edge of the one or more scrims is either edge sealed or capable of being edge sealed to substantially encapsulate the non-woven core layer within the one or more scrims

23. A battery assembly for an electric vehicle comprising the multilayer thermal insulator of claim 22.

24. A flame retardant composition comprising:
water;
a latex binder comprising an acrylic polymer having a glass transition temperature (Tg) ranging from −20° C. to 20° C.;
flame retardant particles comprising ammonium polyphosphate; and
a char forming material comprising —CH₂OH groups.
